(19) United States
(12) Patent Application Publication
(10) Pub. No.: US 2021/0181344 A1
(43) Pub. Date: Jun. 17, 2021

(54) SYSTEM AND METHOD FOR EVALUATING THE PHYSICAL SKILLS OF A PERSON

(71) Applicant: The Power Player Inc., Buffalo, NY (US)

(72) Inventor: Joseph P. GANNON, Buffalo, NY (US)

(21) Appl. No.: 17/189,171

(22) Filed: Mar. 1, 2021

Related U.S. Application Data
(63) Continuation of application No. 15/785,204, filed on Oct. 16, 2017, now abandoned.
Application No. 15/785,204 is a continuation of application No. 14/469,888, filed on Aug. 27, 2014, now abandoned.
Application No. 14/469,888 is a continuation of application No. 13/900,447, filed on May 22, 2013.
(60) Provisional application No. 61/650,394, filed on May 22, 2012.

(51) Int. Cl. G01S 17/88; G06K 9/00; G01S 17/58; G01S 17/86

(52) U.S. Cl. CPC G01S 17/88; G01S 17/86; G01S 17/58; G06K 9/00342

(57) ABSTRACT

An electronic, hand-held device is constructed to capture and aggregate data that pertains to the physical skills of a person, and includes a hand-held computer, and at least one physical-skills-data-capturing component coupled to the computer and in communication with it so that captured data can be processed by the computer. There could be plural physical-skills-data-capturing components coupled to the computer, and one of them may be a physical-skills-data-capturing device that is constructed to capture substantially simultaneously a combination of moving or still pictures.

### CROSS-REFERENCE TO RELATED APPLICATIONS

This application is a continuation of U.S. patent application Ser. No. 15/785,204, filed Oct. 16, 2017, which application is a continuation of U.S. patent application Ser. No. 14/469,888, filed Aug. 27, 2014, which application is a continuation of U.S. patent application Ser. No. 13/900,447, filed May 22, 2013, which application claims the benefit of U.S. Provisional Patent Application No. 61/650,394, filed May 22, 2012, all entitled “SYSTEM AND METHOD FOR EVALUATING THE PHYSICAL SKILLS OF A PERSON”, all of which are incorporated herein by reference for all purposes.

### FIELD OF THE INVENTION

The disclosure relates to devices that are constructed to capture data pertaining to the physical skills of a person.

### SUMMARY

The invention includes an electronic, hand-held device that is constructed to capture and aggregate data that pertains to the physical skills of a person, such as an athlete. One version of the invention is a hand-held electronic device that is constructed to capture substantially simultaneously a combination of moving or still pictures and data. The device includes a suitable computer arrangement with a housing enclosing a one or more circuit boards in communication with a microprocessor, a hard drive, RAM, and a display. Also included is a video camera and a so-called radar gun. The moving pictures could be video, and the still pictures could be digital photographs. The device is controlled by a RECORD/START/STOP button, and all functions will begin simultaneously after pushing the record and start button. Users of the device will be able to play back recordings wherever there are, or save them for analysis at a later date.

### BRIEF DESCRIPTION OF THE DRAWINGS

FIG. 1 is a combination schematic and representational illustration of the device of the invention being used to evaluate the physical skills of a baseball player

FIG. 2 is a combination schematic and representational illustration of the device of the invention being used to evaluate the physical skills of a golfer.

FIG. 3 is a combination schematic and representational illustration of the device of the invention being used to evaluate the physical skills of a tennis player.

### DETAILED DESCRIPTION

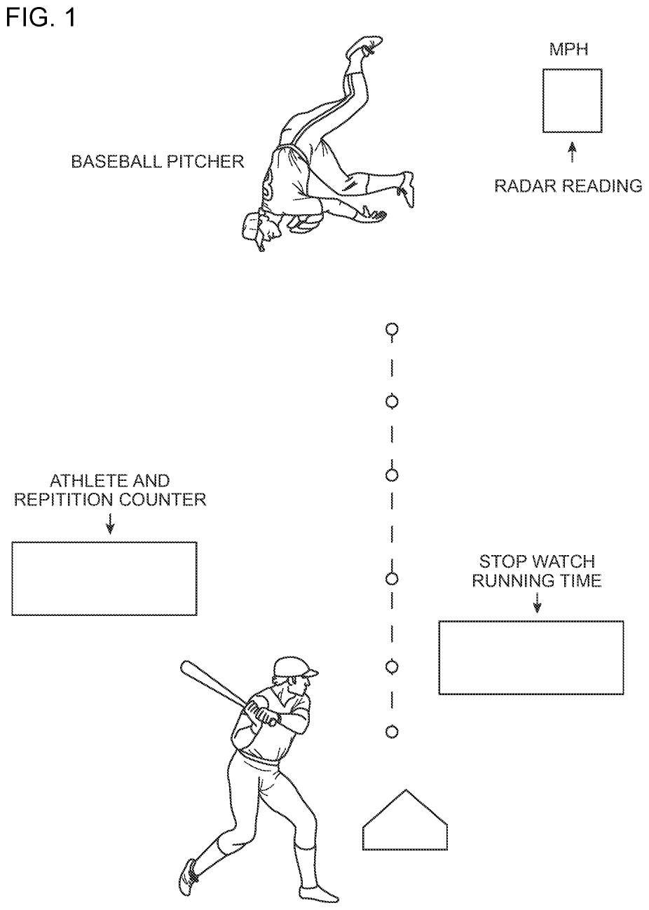

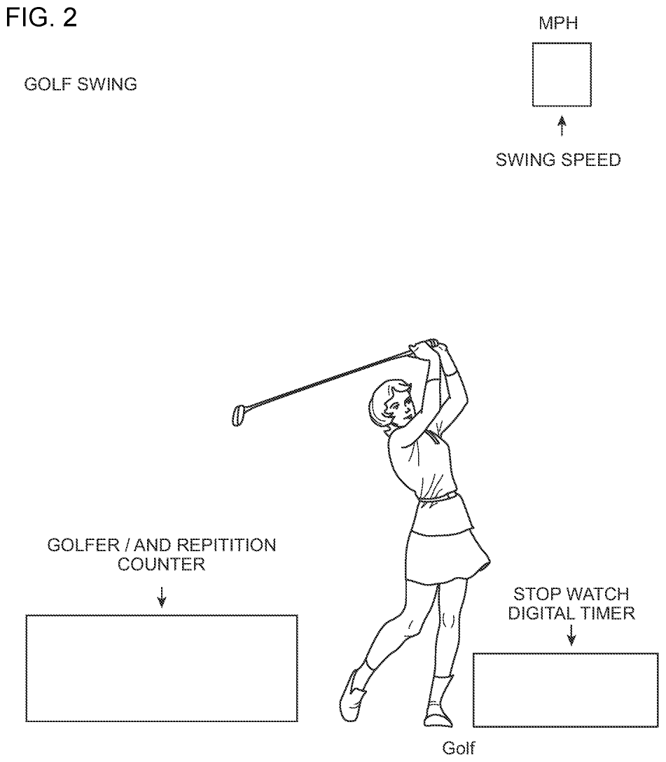

As noted in the Summary, the device is constructed with a suitable display, and examples of the features that are depicted in the display are shown in FIGS. 1-3, illustrating the use of the device for evaluating a baseball player, a golfer, or a tennis player. The device includes the following components: (i) a housing with a handle for holding and operating the device; (ii) a battery, preferably rechargeable for powering the device; (iii) a camera that is capable of taking video and still photographs; (iv) a sensor subsystem that includes an optical radar device for measuring the speed of objects and humans; (v) integrated circuitry, including a suitable microprocessor to control all functions of the device; (vi) a memory-storage device for storing the video/still photographs and the data; and (vii) a display for showing desired video, still pictures and data that were captured by the camera and sensor subsystem and stored in the memory-storage device.

The visual and numerical information that is captured and stored on the device can be used in various ways to evaluating the physical skills of a person, such as an athlete. In the sports field, the device can be used by scouts, recruiters, coaches, instructors, personal trainers, parents or athletes themselves to provide relatively immediate feedback pertaining to the athlete's abilities, skills, weaknesses, areas for improvement etc. The video can be shot to provide visual information from various desired angles, and the saved data can include velocity, timed movements and repetitions associated with physical activity of the athlete. If viewed at after the information was obtained while the athlete was performing physical activities, the device is also constructed to send the data to various viewing devices, such as computer displays, televisions, digital video data players, projectors mobile devices, or any other suitable equipment.

Users of the device will be able visually to track the mechanics of an athlete's motion, and add the captured visual and numerical data for display to assist in evaluating the skills of the athlete, and how the athlete can better their play or avoid injury. The mechanics of an athlete's motion will vary depending upon the sport, however the ability to track body movements in each sport is essential to observe how an athlete physically executes movements in play. That tracking feature also helps to project how the athlete could perform in the future, if corrections are made based upon the evaluation made possible by using the device.

As an example, and referring to FIG. 1, by using the device and showing a baseball pitcher a display like the one shown in FIG. 1, it is possible to show a baseball pitcher how to use their whole body to throw instead of just their arm. The device is constructed to track frame by frame pictures/video of the pitcher's throwing motion, while the sensor subsystem captures the velocity of the ball that the pitcher throws at substantially the same time. This combination of different types of information enables the user to improve a pitcher's throw by demonstrating exactly where in the throw the pitcher's mechanics needs to change or improve. Users can utilize the tool for evaluation, training and guiding improvement in an athlete's performance.

As mentioned above, the device will generate a display that shows secondary data, such as pitch velocity from the radar gun. The sensor subsystem includes a suitable radar device to track the velocity of objects and people. The objects could be thrown, kicked or struck, and the tracked velocity could be associated with how fast the athlete is moving an object, such as swinging a bat. Applications of the device include a baseball pitcher throwing a pitch, a soccer player kicking a soccer ball, a tennis player serving a tennis ball, a hockey player slapping a puck, a golfer swinging a club, a diver jumping off a diving board, etc. Applications can include people who are doing movements related to a sport, an exercise, or a job. For the sports application, the visuals of the athlete's motion mechanics plus the associated velocity readings will provide a unique combination of data to evaluate each person and provide a basis for them to improve.

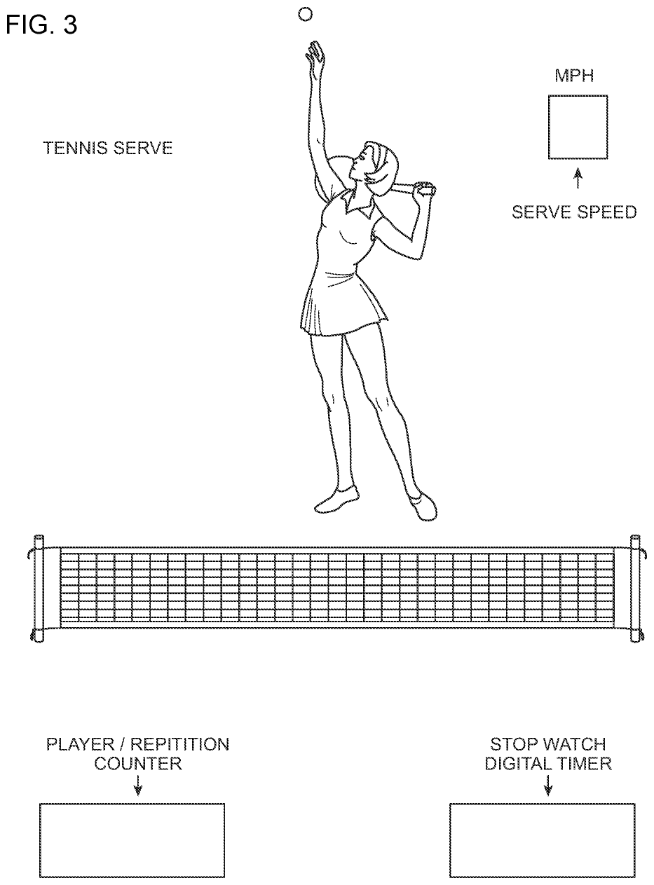

The device may also include a stopwatch to allow for timed data to appear on desired video or still photographs, for example, to assist in evaluating the speed of a runner or skater (Drawing. 1/Figure 3). The stopwatch is constructed to measure time within tenths of a second. That sensitivity will allow evaluation of the first step of an athlete, thereby providing the athlete with information that can lead to improvements in their motion, such as improving a sprinter's first step, i.e. the sprinter's acceleration. The device also tracks motion mechanics through video top isolate particular physical motions of the athlete. This feature would be usable by recruiters, scouts, and coaches/athletes to evaluate a competitor. Examples of applications for this feature include a baseball runner's time from home to first; a baseball catcher's timed throws to second base, a sprinter's first step as well as their sprint; a hockey player's speed with the puck from one end or ice to the other; and a football player's speed after receiving the ball.

The sensor subsystem is also constructed with a repetition counter, the data from which also appears on the display of the device, and can be used to record a variety of data for an athlete throughout competition. When using the counter, manually pushing the stop and start button will cause the counter to begin counting. By using the video information, velocity readings, and stopwatch, will enable users to gauge an athlete's endurance and check if their motion mechanics or velocity decline or improve as they continue to perform pre-selected drills. For example, a starting pitcher's velocity of their first 10 pitches is averaging 91 mph and their motion mechanics is strong. The device continues to record and notes that by the seventh inning of the same game the final 10 pitches (pitches 99-109) average 87 mph with flawed mechanics. As the contest went on the pitcher fatigued, and the device is able to measure how the fatigue affects the pitcher's performance. By using the device, coaches will be able to know when a pitcher is starting to tire, with the possibility of replacing them before their pitches become ineffective.

Another example can be if a tennis player serves a ball 98 mph on the first serve of a match, and 100 mph on the fortieth serve in the same match. This information from the device verifies that the player's endurance is strong throughout the match. An example of the stopwatch component can be applied as follows. The user records a runner's first ten sprints. The stopwatch and repetition counter work together and track the first three sprints at 4.33-minute forty-yard sprint. However, the device records that the runner's last sprint is 4.44-minutes. The user of the device can review the corresponding displays later to observe why the sprinter's speed went down.

The device is constructed with a menu button (either a hardware or software implementation) with various features, including: (i) prompting users to look at the video/pictures on location; (ii) saving the video/pictures, and (iii) erasing desired data. To utilize the erase option, users will be asked twice if they want to erase any data as to ensure nothing is lost accidentally. The menu will also feature an option for recording multiple players in a single event. The device will also allow users to toggle between competitors at one event without losing track of repetitions for each athlete. For example, a scout can film pitchers on opposing teams by selecting “player one” or “player two”. The counter will pick up where each pitcher left off at the previous inning and keep each competitor at one location in order.

The radar and stopwatch components of the device can be integrated into so-called snapshot cameras, computers, and phones containing built in camera equipment. Conversely, it is also possible to construct the device by incorporating a visual/video camera into radar gun equipment. The corresponding video and data can be saved on the memory device component of the device, or can be sent to another external memory component, such as a disc or USB flash drive.

All information from the device can be viewed on location, stored, transferred, downloaded, emailed or viewed at a later date. These features enable the information to be shared with other interested parties who are off location. The device is also constructed for coupling with suitable monitors and external power.

The device can be battery operated or plug operated. By plugging the device in to a power source, it will automatically begin charging the battery that is pre-installed (Drawing 1/FIG. 8, Drawing 3/FIG. 5). The device can be hand-held, or placed on a tripod or other suitable device. The camera feature will have all the usual camera features, including auto zoom, and auto flash, as well as being waterproof.

What is claimed is:

1. An electronic, hand-held device that is constructed to capture and aggregate data that pertains to the physical skills of a person, comprising:
a hand-held computer; and
at least one physical-skills-data-capturing component coupled to the computer and in communication with it so that captured data can be processed by the computer.

2. The device of claim 1, wherein there are plural physical-skills-data-capturing components coupled to the computer.

3. The device of claim 2, wherein there is a physical-skills-data-capturing device that is constructed to capture substantially simultaneously a combination of moving or still pictures.

4. An electronic device for capturing and aggregating date pertaining to the physical skills of a person, comprising:
a housing with a handle for holding and operating the device;
a battery for powering the device;
a camera that is constructed to take video and still photographs;
a sensor subsystem that includes an optical radar device for measuring the speed of objects and humans;
integrated circuitry, including a suitable microprocessor to control all functions of the device;
a memory-storage device for storing the video/still photographs and the data; and
a display for showing desired video, still pictures and data that were captured by the camera and sensor subsystem and stored in the memory-storage device.
